(19) United States
(12) Patent Application Publication
(10) Pub. No.: US 2024/0403890 A1
(43) Pub. Date: Dec. 5, 2024

(54) AUTONOMOUS CLIMATE TECHNOLOGY ECOSYSTEM FOR COMPUTER- GENERATED UNIFORM CARBON CREDIT CERTIFICATES

(71) Applicant: Universal Carbon Holdings Inc., Kittitas, WA (US)

(72) Inventors: Lynn BREWER, Easton, WA (US); Michel JAMMAL, Seattle, WA (US); Dorothy BRAY, High Wycombe (GB)

(73) Assignee: Universal Carbon Holdings Inc., Kittitas, WA (US)

(21) Appl. No.: 18/289,349

(22) PCT Filed: Jul. 22, 2023
(86) PCT No.: PCT/US2023/070786

§ 371 Date: Nov. 2, 2023

Related U.S. Application Data
(60) Provisional application No. 63/369,369, filed on Jul. 25, 2022.
(60) Provisional application No. 63/369,268, filed on Jul. 25, 2022.

(51) Int. Cl. G06Q 30/018; G06F 21/60; G06Q 40/04

(52) U.S. Cl. CPC G06Q 30/018; G06F 21/602; G06Q 40/04

(57) ABSTRACT

A climate technology ecosystem is disclosed that automates the collection and processing of data by way of programmed computer software to automatically generate uniform encrypted carbon credit certificates that can be traded on peer-to-peer exchanges or as derivatives. The Autonomous Climate Technology Ecosystem (ACTE) creates a network of information derived from nine systems designed to: sensor, qualify, measure, encode, encrypt, issue, index, register, and exchange, all of which rely upon artificial intelligence to identify, calculate and quantify the source and origin of carbon and automatically generate uniform encrypted carbon credit certificates based upon the nature and attributes of the carbon and associated CO₂e.

### FIELD OF THE INVENTION

A climate technology ecosystem is disclosed that automates the collection and processing of data by way of programmed computer software to automatically generate uniform encrypted carbon credit certificates that can be traded on peer-to-peer exchanges or as derivatives. The Autonomous Climate Technology Ecosystem (ACTE) can create a network of information derived from nine systems designed to: (1) sense, (2) qualify, (3) measure, (4) encode, (5) encrypt, (6) issue, (7) index, (8) register, and (9) exchange, all of which rely upon probes, drones & satellites, RFID tags, beacons, artificial intelligence, and/or remote sensing to identify, calculate and quantify the source and origin of carbon dioxide (“carbon” or “CO₂”) and automatically generate uniform encrypted carbon credit certificates based upon the nature and attributes of the CO₂e associated with the identified carbon.

### BACKGROUND OF THE INVENTION

There is little argument remaining that the global climate is undergoing a dramatic change—resulting in an increase in climate-related events from raging forest fires to an increase in the number and intensity of tornadoes and hurricanes. Those living in close proximity to areas prone to these events are finding higher homeowner's insurance rates or worse, homeowner's insurance policies are being cancelled as insurance companies look to reduce the risk to economic reserves. The events following Hurricane Katrina in 2005 laid bare the realization that black, indigenous and people of color (BIPOC) communities are often hit the hardest when a climate event occurs. BIPOC communities are either left behind or require significant financial support to rebuild their communities.

Scientists have determined that greenhouse gas (GHG) emissions are primarily responsible for the dramatic changes in these weather-related patterns and that the biggest contributor to the increased GHG emissions is human activity. Over the past 25 years, there has been a growing demand that international communities reduce their GHG emissions in order to solve many of the problems faced when it comes to the impact of climate change. In order to incentivize industries to reduce carbon emissions, a marketplace has developed for trading of carbon credits as a mechanism for offsetting emissions. A carbon credit certificate is a transferrable instrument that certifies CO₂ has been sequestered, reduced, avoided or removed from the atmosphere and that the amount is equivalent (CO₂e) to one metric ton of CO₂. Initially, the market was solely tied to a regulatory scheme called “cap and trade,” which allowed carbon credits to be purchased using tradable certificates in a mandatory carbon market (MCM). Today, the MCM compliance market makes up 17% of the world's emissions and in 2022, the trading of these carbon credits reached a market of $851B. Puro.earth, <<https://puro.earth/>>, Jul. 25, 2022.

Eventually this regulatory market scheme became the foundation for a voluntary carbon market (VCM) where companies that need to reduce their GHG emissions can do so by funding carbon reduction projects through the pre-selling of expected carbon credits. The Bank of England predicts that the demands for carbon credits on the voluntary market will increase by 15-fold by 2030 and 100-fold by 2050. Why Improving the Integrity of Voluntary Carbon Markets Matters for Companies and Net Zero, <<https://www.c-resource.com/2022/01/13/why-improving-the-integrity-of-voluntary-carbon-markets-matters-for-companies-and-net-zero/>>, Jul. 25, 2022. In 2020, the VCM was expected to grow from $0.4B a year to $25B in 2030 and as much as $480B in 2050. A Total of 1.2 Billion Carbon Credits Surplus May Flood The Market, <<https://carboncredits.com/carbon-credits-surplus-market/>>, Jul. 25, 2022. By 2022, the VCM had reached $1B and consisted of 298.4 MM mt/CO₂e according to carboncredits.com. However, Berkley's Public Policy institute states that the registered projects on the VCM consists of nearly 868 MM mt/CO₂e. This lack of transparency and consistency is just part of the problem within the VCM market. The likelihood exists that the overall carbon markets will exceed $4-5T by 2050. If the market continues to consist of removal only projects, the price per carbon credit could reach $224.00 per mt/CO₂e. The “project-based market” of the VCM means the market will be completely undersupplied by 2029 and prices are estimated to shoot up to $224/ton, which will create an inflationary market that will be directly passed along to consumers. By 2050, even with technologies that include direct air capture, there is still only enough supply to meet less than 90% of the demand and prices will still remain at $120/ton. Carbon Offset Prices Could Increase by Fifty-Fold by 2050, <<https://about.bnef.com/blog/carbon-offset-prices-could-increase-fifty-fold-by-2050/>>, Jul. 25, 2022. The long-established derivatives market has a notational value of $1Q; is mature and is designed to hedge commodity pricing from natural resources to agriculture products or livestock. The invention hereunder creates greater supply and reduced prices by facilitating active trading of derivatives of uniform encrypted carbon certificates that are backed by attestation of both the landowner and developer of the certificates for transparency, liquidity and ultimately true price discovery.

Both the MCM and VCM were created to provide monetary incentives to reduce GHGs by allowing for trading of carbon credit certificates. Although there are those that buy and sell offsets as “feel good” social impact incentives sold to individuals, those are not considered to be part of either the MCM or VCM markets. Carbon credits created in the MCM are designed around a binary approach as to whether a regulated entity is above or below its allowable threshold of emissions, whereas carbon credits in the VCM are created from schemes to finance disparate carbon projects and thus the foundation for the creation of the carbon credits is not uniform, making active trading in the VCM nearly impossible.

Article 6.2 of the Paris Agreement provides an accounting framework for international participants and allows for the international transfer of carbon credits between countries. Article 4, Paragraph 13 of the Paris Agreement promotes “integrity, transparency, accuracy, completeness, comparability and consistency, and ensures avoidance of double counting.” Double counting of carbon credits is a serious concern and the retirement of carbon credits from registries provides assurance that an issued carbon credit and the representative certificates are not sold multiple times as a means of solving the climate crises through the removal of GHG from the atmosphere. While an important mechanism for solving the climate crises, this methodology does not afford the active trading of derivatives to hedge climate risk.

In the MCM, the carbon certification process is based upon certification of the reduction of CO₂ emissions for which carbon credits are issued by a regulatory agency that are then actively traded because of their uniformity. However, in the VCM, the process is quite different. In the VCM, the carbon certification process is oblique and the participants are generally sophisticated carbon registrars, companies or futures traders who have significant resources. The myriad sources of carbon projects range from cookstoves in Africa to blue carbon in the oceans to reforestation projects, which take months to qualify as a carbon project through which expected carbon credits from the projects are certified and provide an attestation from both the landowner/leaseholder and the issuer of the encrypted certificates to validate the underlying source of the credit and issuance of the certificate. This leaves a large swath of potential market participants who desire to sell carbon credits originating from the CO₂e contained in but not limited to grazing land, sage land, grassland, forestland, cropland, wetlands, coastal waters, settlements, and other technical projects but they cannot easily do so because the process is opaque, onerous, burdensome, and too expensive. “Few consumers have the time or know-how to conduct extensive analysis. Even those that do may find it extremely difficult to factor all cost components correctly.” Making Sense of the Voluntary Carbon Market: A Comparison of the Carbon Offset Standards, <<https://www.globalcarbonproject.org/global/pdf/WWF_2008_A% comparison%20of %20ofC%20offset%20Standards.pdf>>, Jul. 25, 2022.

There are at least 7-10 registries and dozens of private companies that issue physical carbon credits outside of the registries. Thus, the current model for trading physical carbon credits, while it provides a mechanism to incentivize large companies and industries to offset their carbon emissions, it does not allow for proper price discovery and can be manipulated so that multiple carbon credits can be generated for the same carbon removal, reduction, or avoidance projects resulting in double counting or greenwashing or unverified carbon credits.

Eventually third-party validators came to the market to provide independent verification of the project-based carbon credits that would be available to offset a company's GHG emissions when the project was completed. This method of financing carbon projects by pre-selling expected carbon credits became the foundation for the VCM. To bring further liquidity to the VCM, emissions traders looked at ways to trade the carbon credits but were unable to close their trading positions because no two projects are uniform in nature, causing the ability to actively trade carbon credits to become restrictive. ISDA: The Implications of the FRTB for Trading Carbon: A Global Perspective, <<https://www.isda.org/a/ZeVgE/Implications-of-the-FRTB-for-Carbon-Certificates-A-Global-Perspective.pdf>>, Jul. 25, 2022.

Today, several dozen companies offer third-party verification of carbon projects. However, projects, whether reforestation of a rainforest or the building of a scrubber, are expensive. To finance the development of carbon projects, carbon credits are pre-sold before the project is finished. In some instances, after the carbon credits are bought, the projects are abandoned, thereby eliminating the environmental benefits the project was expected to produce. This method of creating carbon credits produces enormous risk for financiers who fund a carbon project but then receive no economic benefit from selling the expected but never generated carbon credits. Companies that fund carbon projects as a way of generating carbon credits to offset their GHG emissions can be ultimately forced to purchase replacement carbon credits if an offset was taken but never materialized.

Additionally, the cost of validation of a carbon project to verify the expected carbon credits is very expensive which results in the abandonment of some carbon projects when the verification fees are not paid, leaving the market void of unrealized carbon credits. It has been reported that 75% of the cost of creating a carbon credit is the fees associated with verification.

Farmers Struggle to Break Into Booming Carbon Market, <<https://www.reuters.com/business/energy/farmers-struggle-break-into-booming-carbon-credit-market-2021-04-28/>>, Jul. 25, 2022.

“Carbon Dioxide Removal (CDR) will be necessary to fulfil the hundreds of pledges to reach net-zero by 2050. However, as with any industry, standard methodologies and certifications are crucial to guarantee successful and reliable activities. However, buyers and policymakers currently face challenges in evaluating the ecosystem of CDR certification. The issue is not with CDR, nor with individual certifications—some of which may be very robust—but with the lack of transparency in the overall ecosystem.” Snapshot of the Carbon Dioxide Removal Certification and Standards Ecosystem (2021-2022); S. H. Arcusa and S. Sprenkle-Hyppolite. According to the IEA, “[g]lobal CO₂ emissions from energy combustion and industrial processes rebounded in 2021 to reach their highest ever annual level.” Global Energy Review: CO₂ Emissions in 2021, <<https://iea.blob.core.windows.net/assets/c3086240-732b-4f6a-89d7-db01be018f5e/GlobalEnergyReviewCO2Emissionsin2021.pdf>>, Jul. 25, 2022. There is no doubt that GHG emissions need to be reduced and providing a source for securing financing for these projects through incentives is important but a different approach is necessary that allows the ability to speculate or hedge climate risk which are not project-based but rather based on active trading to bring liquidity and scalability to the market. Third-party registries or exchanges are important but not every party needs third-party verification while others need a derivatives market to hedge their risk. The lack of ability to actively trade a position is restraining the funds coming into the VCM based upon the lack of transparency and ability to trade positions and close a trader's position in their risk books. The current market requires traders to retain a “long” position which ultimate inhibits financing from flowing into the VCM.

As companies, particularly publicly-traded companies, have come under scrutiny for their GHG emissions and started to make climate commitments, the price for carbon credits has risen dramatically, in large part because of the limited supply of reliable and tradable instruments. Companies like Microsoft and Amazon created climate commitment funds to invest in companies that would allow these heavy polluting behemoths to meet their carbon commitments sooner. This brought yet new players to the market to create an alternative method for creating carbon credits by “tokenizing” projects. Unable to meet the scrutiny of registrars like Verra, which itself has come under scrutiny requiring the CEO be replaced or the Gold Standard, the new schemes involve the creation of cryptocurrencies as a means of raising capital to fund carbon projects which creates a problem itself as the SEC takes the position that tokens are unregistered securities. Although these new market participants consider themselves decentralized autonomous organizations (“DAOs”), the decisions of late by the SEC is clear that other than Bitcoin, no DAOs truly exist based upon their centralized management structure. These purported “DAOs” do not rely on the accepted third-party verification systems for carbon credits but use opaque proprietary solutions to quantify carbon and then issue coins or tokens as “credits” where governance is created by “consensus” as it relates to the cryptocurrency scheme.

The focus to date has understandably been on the removal or reduction of CO₂ from the atmosphere and each unique carbon project is offered as a solution towards a reduction of 95% of the global GHG by 2050. When each unique project is funded by pre-selling the projected carbon credits, the carbon credits are “retired.” Retiring carbon credits is essential to ensure the carbon credits tied to a specific project are not sold twice. However, this approach is not conducive to establishing these project-based carbon credits as a tradable commodity for hedging climate risk based upon the lack of uniformity in carbon projects, unexpected durability, etc. that limit the scalability which in turn restricts liquidity and prevents true price discovery.

The initial focus of the trading of carbon credits in the MCM allowed for active trading of certificates as incentives to reduce a company's GHG emissions or to avoid regulatory penalties. Issued primarily by the EPA, carbon credits in the MCM are issued by way of certificates with an expiration date. The accepted standard of certificates allows these to be actively traded among traders. Today, only Quebec in Canada, and California and Washington in the United States, have mandatory “cap and trade programs” or the selling of allowances as a permit to pollute, while at the federal level, the United States has been challenged in its approach to federally mandated caps on emissions. It should be pointed out that offsetting emissions is not intended to be a permit to pollute but rather a way to bridge the reduction of GHG emissions and ensure industries eventually innovate or face heavy fines. For example, in Washington state, an allowance to pollute up to 8% of emissions can be offset by purchasing a carbon credit which is evidenced by a carbon credit certificate from the states or other counterparties exceeding the emissions threshold. Companies that emit more than 25,000 mt/CO₂e that fail to report their carbon emissions will face fines up to $50,000 per day. The State of Washington has recovered in just six months—$787,000,000—in its first two auctions of emissions allowances—none of which has gone to create projects that reduce carbon emissions and the cost to the polluters has simply been passed along to the consumers making Washington state the highest priced gas in the United States as transport companies add the cost of the purchase of allowances onto the cost of gasoline.

According to the Rocky Mountain Institute, the actual GHG emissions that are attributable to a company's supply chain are likely 5.5 times higher than its own assets and operational emissions. We Need Better Carbon Accounting, <<https://hbr.org/2022/04/we-need-better-carbon-accounting-heres-how-to-get-there>>, Jul. 25, 2022. Thus, the true level of carbon emissions is being underreported. As an example, Amazon.com only accounts and reports its carbon footprint as that which is directly related to products it sells and not products sold by third parties on Amazon's platform. While Amazon has received a failing (F) grade from the Carbon Disclosure Project in the way it accounts for and offsets its carbon footprint, the reality is that Amazon cannot meet its climate targets if it properly accounts for its entire carbon footprint because there simply are not enough carbon credits available in the marketplace.

Today, the global carbon trading markets exceed SIT, primarily traded on the “futures” market without the selling of actual carbon credits. The price of carbon credits will only skyrocket by 2030 and ultimately 2050-likely, by some estimates, to cause a 50-fold increase. Carbon Offset Prices Could Increase by Fifty-Fold by 2050, <<https://about.bnef.com/blog/carbon-offset-prices-could-increase-fifty-fold-by-2050/>>, Jul. 25, 2022. Although the size of the MCM presently exceeds the VCM, it is expected that by 2050, a strong probability exists that the carbon markets will shift from voluntary offsets to a greater mandate for reduction of carbon footprints, or selling of emission allowances as a way of penalizing companies that pollute. Thus, the demand for carbon credits over the next 28 years cannot be met with the current approach to issuing and trading carbon credits.

Last year, Microsoft bought nearly 200,000 farm-based carbon credits (at an undisclosed price) but it rejected far more than the 5,000,000 available agriculturally-derived carbon credits because of the systemic problems with measuring the particulars related to specific environmental benefits. Farmers Struggle to Break Into the Booming Carbon Market, <<https://www.reuters.com/article/usa-agriculture-carbon-idINKBN2CF1U1>>, Jul. 25, 2022. Today, Microsoft has a $1,000,000 Climate Innovation Fund to accelerate technology deployment of new climate innovations through equity and debt capital. Microsoft Climate Innovation Fund, <<https://www.microsoft.com/en-us/corporate-responsibility/sustainability/climate-innovation-fund?activetab=pivot1:primaryr6>>, Jul. 25, 2022. Amazon.com has a $2B Climate Pledge Fund. Amazon Climate Commitment Fund, <<https://sustainability.aboutamazon.com/about/the-climate-pledge/the-climate-pledge-fund>>, Jul. 25, 2022. Operating similar to venture capital firms, Microsoft and Amazon.com are looking for innovation in which to make direct investments to offset their emissions through prepaid carbon credits.

The present design of the market focuses on environmental benefits but captures only a fraction of the CO₂e available that has been captured, sequestered, removed, or avoided, upon which carbon credits could be issued and monetized by landowners. In fact, Berkley Public Policy institute has created a database of the VCM which indicates only 3,380 registered carbon projects exist with 836,743,023 mt/CO₂e in the VCM (far more than the 298.4 MM mt/CO₂e according to carboncredits.com) which demonstrates the inherent problems. Berkley accounts for more than 3× the registered projects of carboncredits.com which demonstrates the opague nature of the VCM. Meanwhile, Bloomberg indicates that by 2024, there will be no more sources of carbon credits. Thus, between the discrepancy and limited number of active VCM projects and running out of sources of projects means that we simply will not be able to solve the climate crises unless we are able to scale the market. See <<https://gspp.berkeley.edu/research-and-impact/centers/cepp/projects/berkeley-carbon-trading-project>>.

The current market is filled with inefficiencies, complexities and expense and obtaining and registering a tradable carbon credit is onerous and burdensome-leaving potential “inventory” of carbon credits untapped and small landowners and farmers out of participating in the marketplace. This leaves a natural vacuum in the supply-and-demand model; limits the ability for true price discovery; restricts liquidity required to scale the VCM; and forces buyers to go to the MCM to purchase carbon credit certificates, which causes the price to artificially escalate, which causes higher prices to the consumer. Meanwhile, the current VCM model deters new participants who desire to sell carbon credits from the land they own or lease that originate from CO₂e contained in, but not limited to, grassland, sage lands, grazing lands, forestland, cropland, wetlands, coastal waters, settlements, and other technical projects because the process is onerous, burdensome, and too expensive. In summary, this restricts funds from coming into the VCM to solve the climate crises.

In 2012, California began a state “cap and trade” model that created a mandatory offsetting program for heavy polluters using an “auction” method where purchasers bought state issued carbon credits through a quarterly auction. In November 2014, California and Quebec held their first joint auction. The settlement price for the first joint auction was priced $11.86 mt/CO₂e to offset emissions. In May of 2022, the auction closed at $29.85 mt/CO₂e. That price will continue to trend upwards, expected to hit $40 mt/CO₂e by 2025 and $100 per ton by 2029-a 250% increase-which will be passed along to the consumers.

In 2021, Washington state passed the Climate Commitment Act which created a “cap and invest” model that follows California and Quebec in creating a mandatory offset program for heavy polluters by selling allowances. Any company with carbon emissions in excess of 25,000 mt/CO₂e can purchase allowances to offset up to 8% of their current emissions over the 25,000 metric ton threshold. The State of Washington generated more than $757,000 in its first two actions selling these arbitrary allowances. The critical component to this is that in less than one year, the cost of offsetting carbon has gone up 50% and Washington's allowances for polluting are selling for more than $50.00 per metric ton-none of which goes towards reducing GHG but only gets passed along to the consumer.

Meanwhile between 2017 and 2022, prices on the futures market for carbon emissions have gone from $5.00 in 2017 to as high as $90 per metric in 2022 which is a 1,800% increase in a mere five years. According to Bloomberg NEF, it is expected that the price to offset carbon emissions with the purchase of a carbon credit will grow more than 50-fold by 2050. Carney's Bid 10 Grow Carbon Market Rejigged Among Controversy, <<https://www.bloomberg.com/news/articles/2022-03-16/carney-s-bid-to-boost-carbon-market-scaled-back-amid-controversy>>, Jul. 25, 2022. Mark Carney, former head of the Bank of England predicts the total market could reach $100B by 2030 but there is a lack of integrity and clarity of how global trading should function in the current emissions markets. Id. Verifying carbon-capture claims accounts for about 75% of the cost of generating credits, according to Debbie Reed, executive director for the Ecosystem Services Market Consortium (ESMC)—a nonprofit group that includes environmental and agricultural organizations along with companies like General Mills and McDonald's. Farmers Struggle to Break Into Booming Carbon Market, <<https://www.reuters.com/business/energy/farmers-struggle-break-into-booming-carbon-credit-market-2021-04-28/>>, Jul. 25, 2022. Meanwhile, Carney, who states unequivocally “[b]y scaling the voluntary carbon markets [VCM] and allowing a global price [discovery] for carbon to emerge, companies will have the right tools and incentives to reduce the emissions at least cost.” Former Bank of England Governor Mark Carney leads task force to scale global market for CO₂ offsets, <<https://www.greenbiz.com/article/former-bank-england-governor-mark-carney-leads-task-force-scale-global-market-co2-offsets>>, Jul. 25, 2022. And Bloomberg's Akshat Rathi, notes “Brisk sales of meaningless offsets are leading to claims of climate progress that isn't actually happening.” See <<https://carbonbetter.com/story/carbon-offset-registries/>>.

One of the many challenges facing the market is that carbon credits can be purchased for a few cents to a few hundred dollars a metric ton of CO₂e. The disparate nature between auction prices at nearly $30 mt/CO₂e, allowances at more than $50/mt CO₂e, and the carbon futures market trading at $90 mt/CO₂e illustrates the problems that exist with price discovery and the inefficiencies that exist in the creation of tradable carbon credits.

Fighting climate change cannot be dependent upon a few carbon projects. It must involve a robust derivatives market tied to the physical commodity (CO₂e projects) that can be identified easily to bring liquidity to the trading of carbon credit certificates. This mandates an evolution in the methodology of creating uniform encrypted carbon credit certificates that are placed on the blockchain with proper attestation of both the landowner or leaseholder and the issuer of the uniform encrypted carbon credit certificates. The current market cannot scale if based solely upon pre-selling projected carbon credits to finance projects. Without the ability to bring uniform encrypted carbon credit certificates that can be actively traded sufficient to establish forward price curves that can be accounted for through mark-to-market, like any other commodity, to ensure excessive risks are not taken and that trading positions can be closed, the present VCM will become illiquid and the climate crises will not be averted.

### BRIEF SUMMARY OF THE INVENTION

The autonomous climate technology system of the invention (ACTE) identifies sources of CO₂ from such things as grasslands, forestlands, croplands, settlements, wetlands, sage lands, grazing lands, coastal waters, soil and agricultural by-products derived from industrial hemp, straw, corn or any agricultural waste, or even technical CO₂e removal projects through a sensoring system designed to measure the equivalency (CO₂e) to mt/CO₂ within each carbon source. The nature of the source of the CO₂e determines whether the CO₂ has been captured, sequestered, reduced, avoided or removed from the atmosphere. A unique identifier is assigned to a profile of each such carbon source that includes the source, type, product, durability, location and other quantifiable data which is cryptographically encrypted to automatically generate a uniform encrypted carbon credit certificate. An attestation as to the authenticity of the ownership of the land and nature of the uniform encrypted carbon credit certificates is placed on a blockchain to allow peer-to-peer exchange or listing on a carbon exchange trading system for trading as a derivative. The uniform encrypted carbon credit certificates of the invention are uniform across all sources of carbon worldwide and can be actively traded. These tradable instruments create a transparent, cost effective, uniform, and scalable solution that can impact climate change through a liquid and sustainable voluntary carbon emissions trading market and can bring funding to the VCM while incentivizing conservation through monetary benefit. The invention allows for ease-of-use for parties to participate in the VCM through attestation, without third-party verification to buy and sell carbon credits for offsetting CO₂. The collection of data allows for creation of indexed funds that can contain pools of uniform carbon credit certificates for futures trading and hedging of climate risk.

ACTE will increase the supply of valid carbon credits without disrupting the current VCM and allow all quantifiable and attested carbon credits to be actively traded. Through use of the uniform encrypted carbon credit certificates generated by ACTE, greater efficiencies, transparency, and accountability facilitate the scaling of the VCM which is expected to bring greater liquidity to the market.

As used herein, the term CO₂e means the number of metric tons of CO₂ emissions with the same global warming potential as one metric ton of another GHG, including but not limited to CO₂. A carbon credit is equal to one metric ton of CO₂e and a carbon credit certificate certifies that one metric ton of CO₂e captured, sequestered, reduced, avoided or removed from the atmosphere is equal to one metric ton of CO₂. A carbon offset is defined as an intended methodology to voluntarily or by regulatory requirement substitute the physical reduction or removal of CO₂ from atmosphere. A carbon credit is defined as a means by which to offset CO₂ emissions. A carbon offset credit is interchangeable with carbon credit. When referred to herein, carbon credit certificates are tradeable financial instruments.

### BRIEF DESCRIPTION OF THE DRAWINGS

The various features of the invention and the manner of attaining them will be described in greater detail with reference to the following drawings, wherein like designations denote like elements.

FIG. 1 depicts an overview of one embodiment of an Autonomous Climate Technology Ecosystem (ACTE).

FIG. 2 depicts a flowscheme of information between nine elements of the embodiment of the ACTE of FIG. 1.

FIG. 3 depicts an overview of one embodiment of a uniform encrypted carbon credit certificate on the blockchain according to one embodiment of the invention.

FIG. 4 depicts a uniform encrypted carbon credit certificate generation for hemp-derived by-products according to one embodiment of the invention.

FIG. 5 depicts a uniform encrypted carbon credit certificate generation and unique number with cryptographic encryption with unique identity for hemp cultivation and hempcrete/hemp insulation according to one embodiment of the invention.

FIG. 6 depicts a uniform encrypted carbon credit certificate generation and number with cryptographic encryption based on growing agricultural products like corn or grain according to one embodiment of the invention.

### DETAILED DESCRIPTION OF THE INVENTION

The invention relates to an efficient, fast, cost-effective and easy-to-use interface to identify and source carbon credits using an integrated ecosystem (ACTE) that can automatically generate uniform encrypted carbon credit certificates, permitting scalability of the global VCM with verification and attestation of the underlying CO₂ that has been captured, sequestered, reduced, avoided, or removed from the atmosphere. The invention transforms, without dismantling the current fragmented VCM, to automatically and uniformly generate reliable and uniform encrypted carbon credit certificates through the use of autonomous technology, machine learning, artificial intelligence, and remote sensing. The generated uniform encrypted carbon credit certificates are based upon quantifiable attributes of CO₂e, which may or may not be tied to a project, token or company. Scaling based upon a transparent uniform methodology rather than one-off projects with negotiated terms or arbitrary tokens allows for proper price discovery and will bring about liquidity in the VCM. The uniform encrypted carbon credit certificates generated according to the invention can have a short-term duration of one year or longer for origination and the benefits of mark-to-market accounting, allowing for trading similar to that of other commodities on a spot market.

ACTE is designed specifically to allow greater participation in the carbon trading markets by simplifying the process and cost of quantifying CO₂ and generating uniform encrypted carbon credit certificates based on the quantified CO₂. In addition to greater market participants, ACTE allows for a greater supply of tradeable carbon credit certificates generated from a broader spectrum of CO₂e sources, including that which is contained in, but not limited to, grasslands, forestlands, croplands, settlements, wetlands, sage lands, grazing lands, coastal waters, soil and agricultural by-products derived from industrial hemp, straw, corn or any agricultural waste, as well as technical carbon removal projects. While the invention has been described herein with reference to CO₂ and its equivalent CO₂e, the principles, systems and methods can be adapted for any tradable GHG emissions.

ACTE in one embodiment of the invention comprises five integrated systems: (1) Sensoring System, (2) Qualifying System, (3) Measuring System, (4) Coding System, (5) Encrypting System. In one embodiment, ACTE further comprises one or more of four additional systems that may be integrated with systems (1) thru (5): (6) Financial System, (7) Index System, (8) Physical System, and (9) Exchange System. In one embodiment, one or more of the systems (1) thru (9) may be executed by a third-party and information derived from the one or more systems may be transmitted to the operator of ACTE which will provide an attestation of the veracity of the uniform encrypted carbon certificate.

These systems may be resident on a single programmable computer or may be resident on a plurality of programmable computers with data stored on the blockchain, servers, or the cloud. The programmable computers may be remote and any one of the nine systems may be resident on a plurality of programmable computers, forming a network (“the “ACTE Network or ACTEN”). The programmable computers comprising of the ACTEN can be programmed to share, store and analyze information detected, analyzed and quantified by the nine systems. And all of the data in the ACTEN can be provided through a subscription to Data as a Service (DaaS) or Software as a Service (SaaS).

The Sensoring System uses a variety of technologies such as a probe to detect and track a carbon source that constitutes or has been processed into carbon sequestered materials. In one embodiment, servers may collect data from various detection devices, including remote sensing, and may provide tasks to devices communicatively coupled to ACTEN. Various devices and technologies for detection and tracking can be used depending on the nature of the carbon source. There may be alternative technologies to detect and track similar carbon sources, including drones and satellites. Devices may communicate with ACTEN via any now known or later developed wired or wireless connection, microwaves automated, non-automated, computerized or non-computerized, including any other form of communication technology. In one embodiment, a plurality of technologies of carbon tracking and detection may be used, and the results may be compared and/or averaged. Any method and/or system of detecting and tracking a carbon source, now known or later developed, can be used.

As means of illustration only, in one embodiment, hand-held (and autonomous multi-powered, Internet of Things (IoT) (enabled robotic apparatus)) utilizing VisNIR spectroscopy in the form of a cylindrical probe fitted with lenses, sensors, and algorithms may be used to measure carbon levels in ground soils and relay that data to the Sensoring System. In addition to detecting the amount of carbon, the probe can be designed to detect the longitude and latitude of the parcel of land or the location and amount of carbon sequestered materials being measured. In one embodiment, drones, autonomous (and manually operated) IoT and GPS equipped lighter than air and solar enhanced electric flying aircraft, may be used to measure air quality and thermal variations of parcels of land, augmenting the measurements. In one embodiment, RFID tags can be used on pallets of agriculturally derived by-products in which carbon is sequestered to track yield, origination, collection and destination for manufacturing through-put; in one embodiment, this may be the first step for tracking inventory and distribution of carbon sequestration allotments. In one embodiment, beacons (active or passive) utilizing IoT and GPS can be attached to blocks that have been manufactured in a manner that sequesters carbon that allows the distribution of the blocks to be tracked. AI programming, utilizing real time or near real-time Sensoring System data, can analyze health, field and manufacturing data, nature of the environment of the carbon source, including but not limited to the use of heat maps, determining types of soil, environmental temperatures, historical temperatures, typical rainfall, water usage in cultivating agricultural products to determine the critical constructs for capturing and removing greater carbon from the atmosphere. Data stored in ACTEN can be designed to be analyzed and sold on a subscription basis for further data analysis. In addition, data regarding attributes of the carbon source can be recorded that allows identified attributes, including but not limited to, the nature and location of the carbon source and source and origin used in the generation of the uniform carbon credit certificate. In other instances, “remote sensing” of carbon sources will be used for efficiency in the collection of data.

The Qualifying System qualifies the nature of carbon that has been captured/sequestered, reduced/avoided and/or removed from the atmosphere in or by the carbon source utilizing data detected by and recorded in the Sensoring System. Attributes of the carbon such as the nature, source, origin, and location that are detected and recorded by the Sensoring System can be used to calculate expected term or duration and the viability, durability, longevity and permanence of the carbon sequestration or removal of carbon dioxide. Such calculations can be based on predetermined parameters and values and can be calculated by a programmable computer using ML and/or AI programming based on historical and later developed carbon qualification data. Qualification can consider factors such as whether the carbon has been captured and/or sequestered in sustainable carbon crops, including the distribution and sales of the products made from sustainable carbon crops; whether the carbon has been captured/sequestered from land partitioned for sustainably harvesting forest land or other certified habitats or the growth and production of industrial hemp and other sustainable carbon sequestering crops; and whether carbon from the atmosphere has been reduced/avoided by sequestration in hempcrete and/or other certified products that utilize sustainable carbon sequestered materials.

The Measuring System measures and calculates CO₂e and carbon credits based on data and information regarding the amount and attributes of the carbon in the identified carbon sources from the Sensoring System and the Qualifying System. The Measuring System may also use inputs from other qualifying systems in calculating CO₂e and carbon credits. The Measuring System may use methods now known to calculate CO₂e and carbon credits and may also use measures for calculating CO₂e and carbon credits that are later developed in the evolving science of environmental changes. Carbon credits may be quantified as metric tons of CO₂e or may be quantified by any measure later developed.

The Coding System encodes the source, origin and quantity of the CO₂e that has been identified, quantified and measured by the Sensoring System, the Qualifying System and the Measuring System and associates the CO₂e with a unique identifier. This allows for rapid automatic generation of a uniform encrypted carbon credit certificate and allows a match of carbon credits for transparency, integrity and ease of auditing.

The Encrypting System encrypts CO₂e data and any other information desired by the previous systems of ACTE to create a uniform encrypted carbon credit certificate representative of the CO₂e. The Encrypting System places the uniform encrypted carbon credit certificate on a distributed ledger, such as a blockchain, to create a permissionless and trustless system that allows for peer-to-peer transactions.

The Financial System issues the uniform encrypted carbon credit certificate created by the ACTE for trading as a derivative. This instrument will operate similar to derivatives such as oil, energy, or natural gas and may have a one-year term or with an evergreen clause for a longer period of time. Prices will be posted like other derivates on the NYMEX for transparency in trading.

The Index System allows for single commodity spot pricing, multiple component pricing from a combination of indices or a fixed forward price based upon the movement of a combination of indices. This system also allows uniform encrypted carbon credit certificates to be pooled for indexed investment funds to be created.

The Physical System registers the uniform encrypted carbon certificates created by the ACTE to be traded in the VCM peer-to-peer or to be placed on any exchange designed to trade carbon credits or carbon credit certificates. In one embodiment, issued carbon credit certificates are “uniform” carbon credit certificates in that they each represent 1 mt/CO₂e. Carbon credit certificates do not have to be “retired” because each has been uniquely identified and retain their unique identity throughout the trading of the carbon credit certificates. The uniform carbon credit certificates may have an expiration date. In one embodiment, the uniform carbon credit certificates expire in one year or more from the date of issuance. The Physical System may comprise all sources of carbon credits that have an associated ACTE generated uniform carbon credit certificate.

The Exchange System places the issued uniform encrypted carbon credit certificates created by the ACTE on an exchange for the trading of carbon credits as derivatives. In one embodiment, the exchange can be an international exchange that scales the voluntary carbon market and allows for settlement of trades.

In one embodiment, the programmable computers, devices and resources comprising ACTEN can communicate using any technology now know or later developed, including the Internet or other wired or wireless method of communication, for example but not limited to telecommunication networks, computer networks, mobile cellular/wireless data or voice networks, satellite data or satellite networks or microwaves. Computers may be programmed by any programming language now known or later developed. ACTEN may be resident on any type of computer device, including desktop computers, mainframe computers, mobile applications on smart phones and mobile applications on smart tablets and notebooks or remotely stored in the cloud. ACTE may operate on web-based applications designed for example using HTML, CSS, JQuery, Javascript or PHP. Information may be stored in databases such as for example MySql.

Computers comprising ACTEN may be programmed using predetermined machine-learning (ML) algorithms and/or artificial intelligence (AI). Computers comprising ACTEN may further be programmed with relevant standards and laws for the geographic area where the information is detected and/or recorded. Computers comprising ACTEN may be programmed using AI by providing a plurality of various conditional data sets of known standards for sensing, quantifying and qualifying carbon and CO₂e for the purpose of creating carbon credits. This process of “learning” can be repeated for various types of sensing technologies and carbon qualification standards according to the applicable standards, rules and laws in various geographic jurisdictions. Further, as rules and laws change, the programmed computers comprising ACTEN may be reprogrammed in a similar fashion to reflect those changes. As the programmed computers comprising ACTEN “learn” the results may eventually only be randomly viewed by humans to confirm that they are operating within programmed parameters as well as to minimize irregular results. For CO₂e that is quantified and qualified by ACTE, the programmed computers comprising ACTEN may ascertain a pre-determined and post-determined time frame of a sensing event. A video may be obtained to include additional time frames before and after an event. ACTE can assign a unique identifier to a sensing event and store data on servers that may be required for determination and calculation of CO₂e or may otherwise be desired. The data for example may be viewable only to persons seeking to certify the accuracy of the CO₂e underlying a carbon project.

The AI rapidly mines available CO₂ projects and carbon credit certificates and atmospheric CO₂ and utilizes a computing process, a computerized system, or machine-readable medium that may include but is not limited to residing on ACTEN or any other communicatively coupled device, server, platform, storage device, mobile or satellite device or network from which uniform carbon credit certificates can be generated.

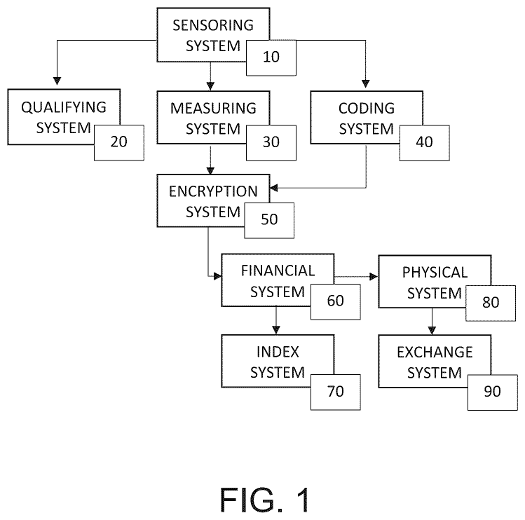

Turning to the figures, FIG. 1 depicts an overview of nine systems that in one embodiment comprise ACTE: Sensoring System 10, Qualifying System 20, Measuring System 30, Coding System 40, Encrypting System 50, Financial System 60, Index System 70, Physical System 80, and Exchange System 90.

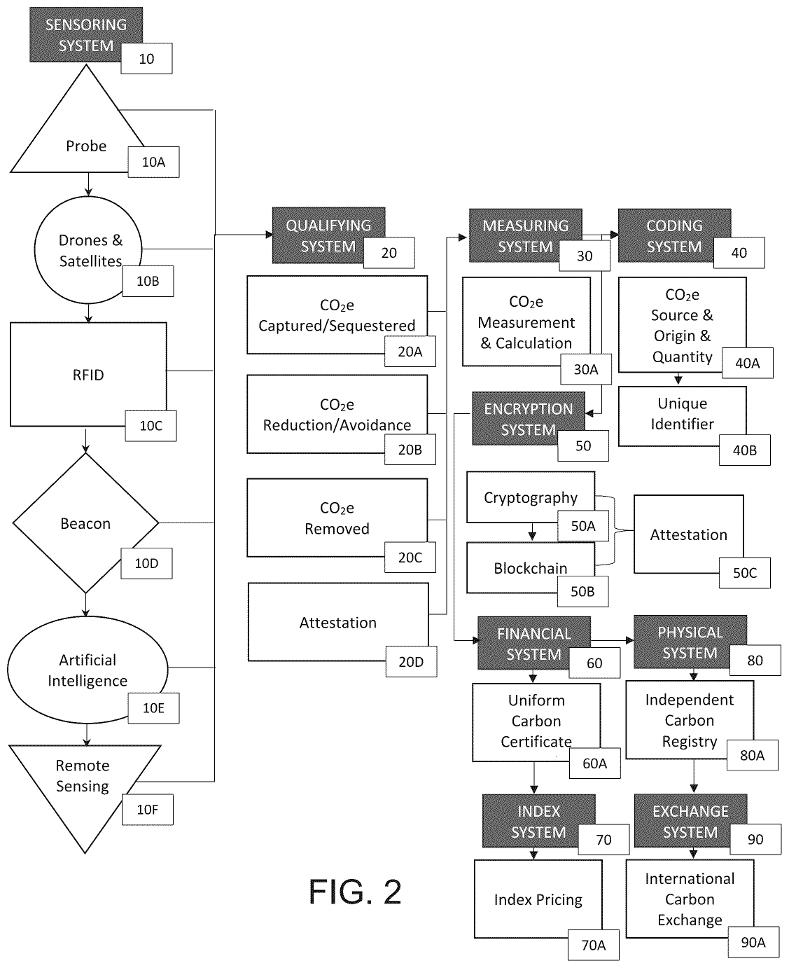

FIG. 2 depicts a flowscheme of information between the nine systems according to the ACTE of FIG. 1. At 10A, Sensoring System 10 detects and tracks with a detection device, such as a probe, a carbon source that has been processed into carbon sequestered materials. At 10B, the probe or other detection device can detect the longitude and latitude of the parcel of land or the location and amount of carbon sequestered materials being measured. Drones, autonomous (and manually operated) IoT and GPS equipped lighter than air and solar enhanced electric flying aircraft, may be used to measure air quality and thermal variations of parcels of land, augmenting the measurements. At 10C, tracking devices such as RFID tags can be used on pallets of carbon sequestered materials such as agriculturally derived by-products to track yield, origination, collection and destination for manufacturing through-put. At 10D, beacons (active or passive) utilizing IoT and GPS can be attached to blocks that have been manufactured in a manner that sequesters carbon that allows the distribution of the blocks to be tracked globally. At 10E, AI programming, utilizing real time or near real-time Sensoring System data, can analyze health, field and manufacturing data, nature of the environment of the sourced carbon, including but not limited to the use of heat maps, determining types of soil, environmental temperatures, historical temperatures, typical rainfall, water usage in cultivating agricultural products to determine the critical constructs for capturing and removing greater carbon from the atmosphere. At 10F, remote sensing of carbon present in the soil, grazing lands, sage lands, coastal waters, grasslands, forestlands, croplands, settlements, wetlands, and agricultural by-products and confirm carbon claiming to be present in carbon projects for efficiency of validation and verification.

Qualifying System 20 qualifies the nature of carbon that has been captured/sequestered at 20A, reduced/avoided at 20B and/or removed at 20C from the atmosphere utilizing data detected by and recorded in Sensoring System 10. At 20D, the authenticity of the ownership of the location of the carbon source such as the land where the carbon source is located is attested to by the landowner and/or leaseholder.

Measuring System 30 measures and calculates CO₂e and carbon credits at 30A based on data and information from Sensoring System 10 and Qualifying System 20.

Coding System 40 encodes at 40A the source, origin and quantity of the CO₂e that has been identified, quantified and measured by Sensoring System 10, Qualifying System 20 and Measuring System 30 and associates that CO₂e with a unique identifier at 40B.

Encrypting System 50 encrypts CO₂e data and other information from Sensoring System 10, Qualifying System 20, Measuring System 30 and Coding System 40 at 50A to create a uniform encrypted carbon credit certificate representative of the CO₂e. The uniform encrypted carbon credit certificate is then placed on a distributed ledger such as a blockchain at 50B. At 50C, the operator of ACTE attests to the authenticity of the uniform encrypted carbon certificate.

Financial System 60 issues a uniform encrypted carbon credit certificate at 60A that can be traded in the VCM either peer-to-peer or placed on any exchange designed to trade carbon credits or carbon credit certificates. In one embodiment, the Financial System may comprise all sources of carbon credits that have an associated ACTE generated uniform encrypted carbon credit certificate.

Index System 70 calculates single commodity spot pricing, multiple component pricing from a combination of indices or a fixed forward price based upon the movement of a combination of indices at 70A. Uniform encrypted carbon credits identified in Coding System 40 according to the source and origin of the CO₂e by categories for trading strategies across the spectrum of characteristic of issued uniform encrypted carbon credit certificates created by ACTE are pooled by indices 70A.

Physical System 80 registers or ties uniform encrypted carbon credits created by ACTE to a registered carbon project at 80A.

Exchange System 90 places generated and issued uniform encrypted carbon credit certificates created by ACTE on an exchange 90A for the trading of the carbon credits in the derivative markets as financial instruments.

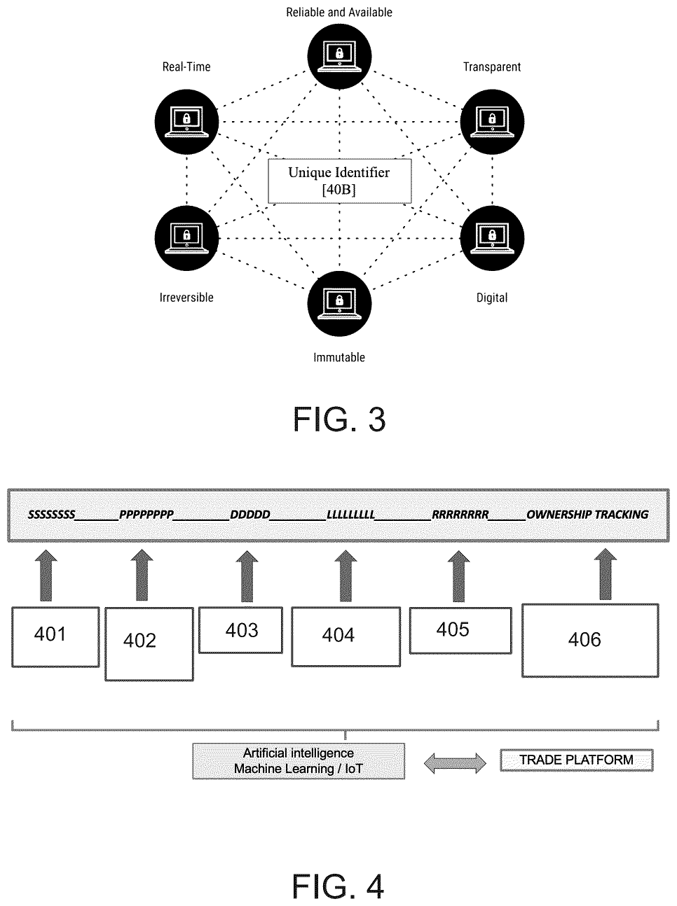

FIG. 3 depicts an overview of one embodiment of a uniform encrypted carbon credit certificate created by ACTE on blockchain according to one embodiment of the invention.

FIG. 4 depicts a uniform encrypted carbon credit certificate as placed on a trading platform for hemp-derived by-products according to one embodiment of the invention by ACTE utilizing AI and ML/IoT and information derived from the nine systems of FIG. 1, which uniform encrypted carbon credit certificate is placed on a trade platform by the Exchange System 90. At 401, information SSSSSSS comprises output from Sensor System 10 comprising soil sensor, drone and satellite location of hemp-derived by-products that sequester CO₂e. At 402, PPPPPPPP comprises the sequestered CO₂e product, here hemp-derived by-products as qualified by Qualifying System 20. At 403, DDDDD comprises the date of production of the sequestered CO₂e product, here hemp-derived by-products. At 404, LLLLLLLLL comprises a length of sequestration of the CO₂e in the hemp-derived by-products as determined by Measuring System 30. At 405, RRRRRRRR comprises the date of expiration of the uniform encrypted carbon credit certificate. At 406, OWNERSHIP TRACKING tracks other information, for example, if there are restrictions limiting the time of ownership of the uniform encrypted carbon credit certificate; or other restrictions such as amount of sequestered CO₂e represented in uniform encrypted carbon credit certificates by an owner. For example, there may be a limit of 1 year per metric ton of sequestered CO₂e or other limits.

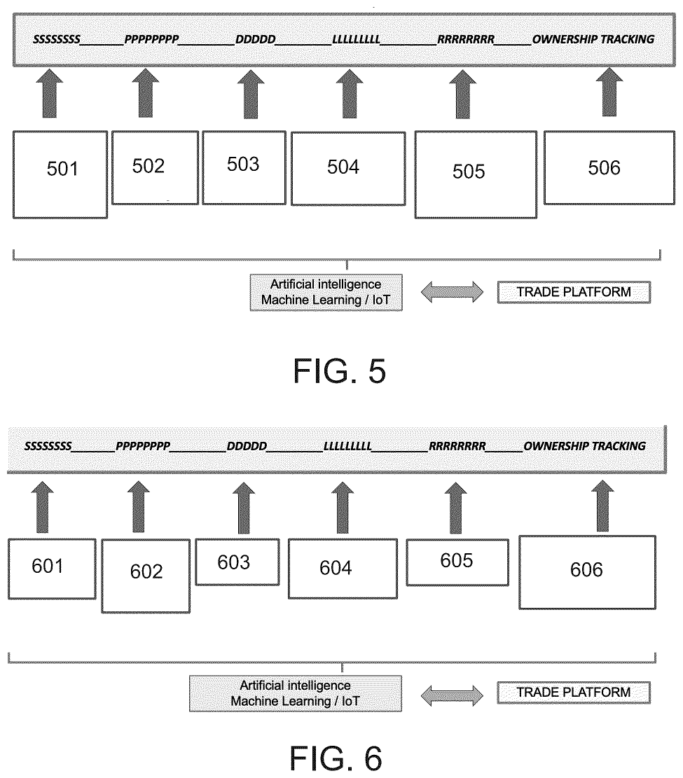

FIG. 5 depicts a uniform encrypted carbon credit certificate and unique number with cryptographic encryption with unique identifier as placed on a trading platform for hemp-derived by-products according to one embodiment of the invention by ACTE utilizing AI and ML/IoT and information derived from the nine systems of FIG. 1, which uniform encrypted carbon credit certificate is placed on a trade platform by the Exchange System 90. At 501, information SSSSSSS comprises output from Sensoring System 10 comprising soil sensor, drone and satellite location of cultivation and manufacturing of sequestered CO₂e product. At 502, PPPPPPPP comprises the sequestered CO₂e product, here, hempcrete blocks and buildings, as qualified by Qualifying System 20. At 503, DDDDD comprises the date of production of the sequestered CO₂e product, here hempcrete blocks and buildings. At 504, LLLLLLLLL comprises a length of sequestration of the CO₂e in the hemp-derived by-products as determined by Measuring System 30 for example 150 years for a hempcrete building. At 505, RRRRRRRR comprises the date of expiration of the uniform encrypted carbon credit certificate, for example 1 year. At 506, OWNERSHIP TRACKING tracks other information, for example, if there are restrictions limiting the time of ownership of the uniform encrypted carbon credit certificate; or other restrictions such as amount of sequestered CO₂e represented in uniform encrypted carbon credit certificates by an owner. For example, there may be a limit of 1 year per metric ton of sequestered CO₂e or other limits.

FIG. 6 depicts a uniform carbon credit certificate generation and number with cryptographic encryption as placed on a trading platform based on growing agricultural products like corn or grain according to one embodiment of the invention by ACTE utilizing AI and ML/IoT and information derived from the nine systems of FIG. 1, which uniform encrypted carbon credit certificate is placed on a trade platform by the Exchange System 90. At 601, information SSSSSSS comprises output from Sensoring System 10 comprising soil sensor, drone and satellite location of agricultural products such as corn or grain that sequester CO₂e. At 602, PPPPPPPP comprises the sequestered CO₂e product, here corn or grain, as qualified by Qualifying System 20. At 603, DDDDD comprises the date of production of the sequestered CO₂e product, here corn or grain. At 604, LLLLLLLLL comprises a length of sequestration of the CO₂e in the corn or grain as determined by Measuring System 30. At 605, RRRRRRRR comprises the date of expiration of the uniform encrypted carbon credit certificate, for example 1 year. At 606, OWNERSHIP TRACKING tracks other information, for example, if there are restrictions limiting the time of ownership of the uniform encrypted carbon credit certificate; or other restrictions such as amount of sequestered CO₂e represented in uniform encrypted carbon credit certificates by an owner. For example, there may be a limit of 1 year per metric ton of sequestered CO₂e or other limits.

The invention has been described in terms of sequestered CO₂e products for illustration purposes only. The invention is not limited to sequestered CO₂e products or any particular source of sequestered CO₂e products and may be used in connection with any tradable GHG emissions. Further, while various embodiments have been described in terms of the nine systems (1)-(9), various embodiments utilizing some but not all of the systems are included in the description of the invention. Finally, while all the steps of the nine systems may be carried out by a single operator, the invention envisions various steps to be carried out by third parties which provide information and data to the ACTE operator which information and data can be used to generate uniform encrypted carbon credit certificates.

What is claimed is:

1. An autonomous climate technology ecosystem for computer-generation of uniform carbon credit certificates comprising:
a programmable computer system, the programmable computer system comprising one or more programmable processors, one or more memory units, one or more searchable databases, and one or more communications interfaces,
a sensoring system;
a qualifying system;
a measuring system;
a coding system; and
an encrypting system,
wherein the sensoring system, qualifying system, measuring system, coding system, and encrypting system are in communication with the programmable computer system and with each other over the one or more communications interfaces;
wherein the sensoring system comprises one or more detection devices that detect and track one or more carbon sources that may constitute or may have been processed into one or more carbon sequestered materials and records data relating to the one or more carbon sources in the one or more memory units of the programmable computer system, wherein the recorded data comprise nature, source, origin, and location of the one or more carbon sources;
wherein the qualifying system is programmed to qualify the nature of the carbon detected and tracked by the sensoring system and records the qualified nature of the carbon in the one or more memory units of the programmable computer system,
wherein the measuring system is programmed to measure and calculate CO₂e based on the carbon that is detected and tracked by the sensoring system and records the calculated carbon credits of the CO₂e in the one or more memory units of the programmable computer system,
wherein the coding system is programmed to encode the source, origin and quantity of the CO₂e that has measured and calculated by the measuring system and associates the CO₂e with a unique identifier, and thereafter records the unique identifier of the CO₂e in the one or more memory units of the programmable computer system,
wherein the encrypting system is programmed to encrypt information comprising data relating to the CO₂e that has measured and calculated by the measuring system to create one or more uniform encrypted carbon credit certificates that are representative of the amount and source of the CO₂e and thereafter to place the one or more uniform encrypted carbon credit certificates on one or more distributed ledgers.

2. The autonomous climate technology ecosystem for computer-generation of uniform carbon credit certificates of claim 1, wherein at least one of the one or more distributed ledgers comprise a blockchain.

3. The autonomous climate technology ecosystem for computer-generation of uniform carbon credit certificates of claim 1, wherein authenticity of ownership of a location of the carbon source is attested to by a landowner or a leaseholder of the location.

4. The autonomous climate technology ecosystem for computer-generation of uniform carbon credit certificates of claim 1, wherein an operator of the autonomous climate technology ecosystem for computer-generation of uniform carbon credit certificates attests to the authenticity of the uniform encrypted carbon certificate.

5. The autonomous climate technology ecosystem for computer-generation of uniform carbon credit certificates of claim 1 further comprising a financial system, wherein the financial system issues one or more of the uniform encrypted carbon credit certificates for trading in one or more voluntary carbon markets.

6. The autonomous climate technology ecosystem for computer-generation of uniform carbon credit certificates of claim 5, wherein the voluntary carbon markets comprise peer-to-peer or on any exchange that trades carbon credits or carbon credit certificates.

7. The autonomous climate technology ecosystem for computer-generation of uniform carbon credit certificates of claim 1 further comprising an index system in communication with the programmable computer system over the communications interface, wherein the wherein the index system calculates commodity spot pricing, multiple component pricing or fixed forward pricing for the one or more uniform encrypted carbon certificates.

8. The autonomous climate technology ecosystem for computer-generation of uniform carbon credit certificates of claim 1 further comprising a physical system in communication with the programmable computer system over the communications interface, wherein the physical system registers the one or more uniform encrypted carbon certificates to be traded in one or more voluntary carbon markets.

9. The autonomous climate technology ecosystem for computer-generation of uniform carbon credit certificates of claim 1, further comprising an exchange system in communication with the programmable computer system over the communications interface, wherein the wherein the exchange system places the one or more uniform encrypted carbon credit certificates on an exchange for the trading of carbon credits as derivatives.

10. The autonomous climate technology ecosystem for computer-generation of uniform carbon credit certificates of claim 1, wherein the sensoring system detects carbon in grasslands, forestlands, croplands, settlements, wetlands, sage lands, grazing lands, coastal waters, soil and agricultural by-products derived from industrial hemp, straw, corn, any agricultural waste and combinations thereof.

11. The autonomous climate technology ecosystem for computer-generation of uniform carbon credit certificates of claim 10, wherein the one or more detection devices used by the sensoring system to detect the one or more carbon sources comprise drones, autonomous IoT equipped lighter than air electric flying aircraft, manually operated IoT equipped lighter than air electric flying aircraft, and combinations thereof.

12. The autonomous climate technology ecosystem for computer-generation of uniform carbon credit certificates of claim 11, wherein the sensoring system further detects health, field and manufacturing data of the one or more carbon sources; nature of the environment of the one or more carbon sources, wherein the nature of the environment comprises the use of heat maps, determination of soil type, environmental temperature, historical temperature, typical rainfall and water usage in cultivating agricultural products.

13. The autonomous climate technology ecosystem for computer-generation of uniform carbon credit certificates of claim 1, wherein at least one of the programmable processors is programmed using predetermined machine-learning algorithms (ML), artificial intelligence (AI) and combinations thereof.

14. The autonomous climate technology ecosystem for computer-generation of uniform carbon credit certificates of claim 13, wherein at least one of the programmable processors is programmed using ML, AI or combinations thereof by utilizing standards and laws for the geographic area where the one or more carbon sources are detected by the sensoring system.

15. The autonomous climate technology ecosystem for computer-generation of uniform carbon credit certificates of claim 14, wherein at least one of the programmable processors is programmed using ML, AI and combinations thereof by providing a plurality of data sets of known standards for sensing, quantifying and qualifying carbon.

16. A method of computer-generation of computer-generation of uniform carbon credit certificates utilizing the autonomous climate technology ecosystem of claim 1 comprising:
sensing, detecting and tracking one or more carbon sources that may constitute or may have been processed into one or more carbon sequestered materials by a sensoring system and recording data relating to the one or more carbon sources in one or more memory units of a programmable computer system, wherein the recorded data comprise nature, source, origin, and location of the one or more carbon sources;
thereafter qualifying the nature of the carbon detected and tracked by the sensoring system by a qualifying system and recording the qualified nature of the carbon in the one or more memory units of the programmable computer system;
thereafter measuring and calculating CO₂e and associated carbon credits of the detected carbon by a measuring system and recording the calculated carbon credits of the CO₂e in the one or more memory units of the programmable computer system;
thereafter encoding the source, origin and quantity of the CO₂e by a coding system and associating the CO₂e with a unique identifier, and thereafter recording the unique identifier of the CO₂e in the one or more memory units of the programmable computer system; and
encrypting information comprising data relating to the CO₂e to create one or more uniform encrypted carbon credit certificates by an encoding system and thereafter placing the one or more uniform encrypted carbon credit certificates on one or more distributed ledgers,
wherein the programmable computer system comprises one or more programmable processors, one or more memory units, one or more searchable databases, and one or more communications interfaces,
wherein each of the sensoring system, qualifying system, measuring system, coding system, and encrypting system are in communication with the programmable computer system and further in communication with each other over the one or more communications interfaces.

17. The method of computer-generation of uniform carbon credit certificates of claim 16, wherein at least one of the one or more distributed ledgers comprises a blockchain.

18. The method of computer-generation of uniform carbon credit certificates of claim 16, wherein authenticity of ownership of a location of the carbon source is attested to by a landowner or a leaseholder of the location.

19. The method of computer-generation of uniform carbon credit certificates of claim 16, wherein an operator of the autonomous climate technology ecosystem for computer-generation of uniform carbon credit certificates attests to the authenticity of the uniform encrypted carbon certificate.

20. The method of computer-generation of computer-generation of uniform carbon credit certificates of claim 16, wherein one or more of the uniform encrypted carbon credit certificates are issued for trading in at least one or more voluntary carbon markets by a financial system.

21. The method of computer-generation of uniform carbon credit certificates of claim 16, wherein commodity spot pricing, multiple component pricing or fixed forward pricing for one or more of the uniform encrypted carbon certificates is calculated by an indexing system.

22. The method of computer-generation of uniform carbon credit certificates of claim 16, wherein one or more of the uniform encrypted carbon certificates are registered to be traded in one or more voluntary carbon markets by a physical system.

23. The method of computer-generation of uniform carbon credit certificates of claim 16, wherein one or more of the uniform encrypted carbon credit certificates are placed on at least one exchange for the trading of carbon credits as derivatives.

24. The method of computer-generation of uniform carbon credit certificates of claim 16, wherein the sensoring system detects carbon in grasslands, forestlands, croplands, settlements, wetlands, sage lands, grazing lands, coastal waters, soil and agricultural by-products derived from industrial hemp, straw, corn, any agricultural waste and combinations thereof.

25. The method of computer-generation of uniform carbon credit certificates of claim 16, wherein at least one of the programmable processors is programmed using predetermined machine-learning algorithms (ML), artificial intelligence (AI) and combinations thereof.

26. A method of computer-generation of computer-generation of uniform carbon credit certificates utilizing the autonomous climate technology ecosystem of claim 1 comprising:
receiving over a communications interface information and data regarding one or more carbon sources that may constitute or may have been processed into one or more carbon sequestered materials from a sensoring system that has sensed, detected and tracked the one or more carbon sources and recording the received information and data relating to the one or more carbon sources in one or more memory units of a programmable computer system, wherein the recorded data comprise nature, source, origin, and location of the one or more carbon sources;
thereafter qualifying the nature of the carbon detected and tracked by the sensoring system by a qualifying system and recording the qualified nature of the carbon in the one or more memory units of the programmable computer system;
thereafter measuring and calculating CO₂e and associated carbon credits of the detected carbon by a measuring system and recording the calculated carbon credits of the CO₂e in the one or more memory units of the programmable computer system;
thereafter encoding the source, origin and quantity of the CO₂e by a coding system and associating the CO₂e with a unique identifier, and thereafter recording the unique identifier of the CO₂e in the one or more memory units of the programmable computer system; and
thereafter encrypting information comprising data relating to the CO₂e to create one or more uniform encrypted carbon credit certificates by an encoding system and thereafter placing the one or more uniform encrypted carbon credit certificates on one or more distributed ledgers,
wherein the programmable computer system comprises one or more programmable processors, one or more memory units, one or more searchable databases, and one or more communications interfaces.
